(19) United States
(12) Patent Application Publication
(10) Pub. No.: US 2011/0217558 A1
(43) Pub. Date: Sep. 8, 2011

(54) CHEMICAL COMPOSITION AND METHOD OF APPLYING SAME TO ENHANCE THE ADHESIVE BONDING OF GLASS LAMINATES

(76) Inventors: Paul H. Brogan, Houston, TX (US); Jay M. Wendell, JR., The Woodlands, TX (US)

(21) Appl. No.: 12/866,722

(22) PCT Filed: Dec. 21, 2007
(86) PCT No.: PCT/US07/88691

§ 371 Date: Nov. 17, 2010

Related U.S. Application Data
(63) Continuation of application No. 11/649,965, filed on Jan. 5, 2007.

(51) Int. Cl. B32B 17/06; C09D 7/12; C03C 27/10

(52) U.S. Cl. 428/426; 106/287.24; 106/287.1; 156/104

(57) ABSTRACT

A chemical composition and method of applying same between glass and attached layer(s) of polyester or other plastic safety/security films to enhance the bonding of the applied adhesive therebetween as well as the strength of the glass laminate construction. In a preferred embodiment, the chemical composition is an acrylic-based mixture, containing alcohol, glycol, a slip agent, and a wetting agent. In an alternative preferred embodiment, the chemical composition is a silane-based mixture, containing alcohol, glycol, and a slip agent. The preferred embodiments of the invention are used in combination with currently available glass laminate systems to enhance the bonding and adhesion thereof.

### BACKGROUND OF THE INVENTION

1. Field of the Invention

This invention relates generally to glass laminate structures for use in safety and security applications. Specifically, this invention relates to a chemical composition, and method of applying same, that enhances the adhesive bonding of glass laminates.

2. Description of the Prior Art

Impact resistant glass laminates were first introduced in the early 1900s and are well known in the art today for use in safety and security glass applications. While impact resistant glass laminates were first introduced for use as automobile glass, they have primarily been limited to similar safety and security applications due to their high production costs, especially in mass quantities. Impact resistant glass laminates have traditionally been constructed using alternating layers of glass and plastic sheeting with adhesive interlays. For example, bullet resistant glass is conventionally constructed with several glass sheets connected together with polyvinyl butyral sheets and with a polycarbonate layer bonded on the inside face of the final glass sheet using a thermoplastics polyurethane layer. The polycarbonate layer provides additional strength, and to a small degree, elasticity, to the glass upon impact but primarily provides good resistance to spalling. In addition to the high production costs, the alternating layers of glass and plastic have also proven cumbersome due to their size and weight. In recent years, innovations in safety and security glass laminates have primarily focused on improving performance (i.e. impact resistance) while making the glass laminates more lightweight, less bulky, and less expensive to produce in mass quantities.

For example, U.S. Pat. No. 5,368,904 issued to Stephinson discloses a bullet resistant glass screen made from a number of glass sheets separated by air gaps. A pressure sensitive adhesive is used to affix polyester security film to the front and rear faces of the glass sheets. The combination of air gaps and the polyester security film increases the resistance of the glass screen while reducing weight per volume; however, the glass screen remains bulky and cumbersome.

In another example, U.S. Pat. No. 5,645,940 issued to Teddington, Jr. discloses a shatter resistant glass having a single glass sheet with an optically transparent polyester coating layer applied to the rear face of the glass sheet using a pressure sensitive acrylic resin adhesive. With only one glass sheet and plastic coating layer, the shatter resistant glass of the '940 patent is easy and inexpensive to produce while providing adequate shatter and spalling resistance. The '940 patent also discloses the importance of the adhesive strength between the glass sheet and the transparent polyester coating layer as a key parameter for improving the shatter resistant properties of the shatter resistant glass. The '940 patent suggests increasing the thickness of the adhesive layer in order to increase the shatter resistance properties of the glass-plastic construction. However, as disclosed, optical transparency is sacrificed as the thickness of the adhesive layer is increased.

Several commercial examples of glass laminates have a similar structure as the '940 patent in that a polyester film with extreme strength properties, such as Mylar®, is applied to a single glass sheet in order to increase the overall strength and bullet resistance of the glass. The polyester film is usually pre-coated with an adhesive, such as an acrylic resin, which permits the polyester film to be bonded to one side of a glass sheet by applying a mild pressure. Normally, a soap and water solution is applied to the surface of the glass to be covered by the polyester film, and in some cases, to the adhesive surface of the polyester film. After the film is applied to the glass, the soap and water solution allows the polyester film to be slightly moved and properly aligned on the glass surface with greater ease prior to the setting of the adhesive. A simple squeegee is used to remove any excess soap and water solution from between the film and glass surfaces as well as remove any air bubbles that may have developed between the film and the glass upon application. However, the soap and water solution used in applying the polyester films to glass sheets does not impart any known enhanced strength or other properties to the glass laminate structure.

The foregoing illustrates a few of the shortcomings of the prior art. If lightweight, less bulky glass laminates with bullet resistant properties are desired, then the optical transparency of the glass structure may be sacrificed. Conversely, if optical transparency is more desirable then the bullet resistant properties of the glass-plastic structure may be compromised. Therefore, a glass laminate structure is highly desirable which combines bullet resistant properties within a lightweight, more compact, and optically transparent glass-plastic structure. A preferred embodiment of the invention disclosed herein provides increased strength and bullet resistant properties to a wide variety of glass laminate structures without adversely affecting the weight, bulk or optical transparency of the glass-plastic construction.

3. Identification of Objects of the Invention

A primary object of the invention is to provide a chemical composition and method of applying same for enhancing the adhesion bonding between glass laminate layers;

Another object is to provide a chemical composition and method of applying same which increases the strength and bullet resistant properties of a glass laminate structure without sacrificing optical transparency;

Another object is to provide a chemical composition and method of applying same which increases the strength and bullet resistant properties of a glass laminate structure without adversely increasing its weight or bulk;

Another object is to provide a chemical composition and method of applying same which can be employed with a wide variety of currently designed and commercially available glass laminate structures to increase glass strength, bullet resistance, and reduce spalling while not adversely increasing their weight, bulk, or opacity.

Other objects, features, and advantages of the invention will be apparent to one skilled in the art from the following specification and drawings.

### SUMMARY OF THE INVENTION

The objects identified above, along with other features and advantages of the invention are incorporated in a chemical composition and method of applying same between glass-plastic constructions in order to enhance the adhesion bonding therebetween as well as the strength and bullet resistant properties of the glass laminate structure as whole. In a preferred embodiment of the invention, the chemical composition is an acrylic-based mixture, containing alcohol, glycol, a slip agent, and a wetting agent. In an alternative preferred embodiment, the chemical composition is a silane-based mixture, containing alcohol, glycol, and a slip agent. The preferred embodiments of the chemical composition are arranged and designed to be used with currently available polyester film/glass sheet constructions. The chemical composition of a preferred embodiment of the invention is applied to the glass onto which the polyester sheet is to be applied and to the adhesive side of the polyester film. As with prior art soap and water mixtures, the chemical composition allows the polyester film to be moved and properly aligned on the glass sheet with greater ease after initial placement. Moreover, use of the chemical composition between the polyester film and the glass sheet greatly enhances the adhesion of the polyester film to the glass as well as the overall strength and bullet resistant properties of the glass laminate structure. Several research tests have been conducted which confirm the enhanced glass laminate strength and bullet resistant properties imparted by the preferred embodiments of the chemical composition and method of applying same.

### BRIEF DESCRIPTION OF THE DRAWINGS

By way of illustration and not limitation, the invention is described in detail hereinafter on the basis of the embodiments represented in the accompanying figures, in which:

FIG. 1 is a cross-sectional view of a glass laminate structure employing the chemical composition of a preferred embodiment of the invention to enhance the adhesive bond between a polyester or other plastic security film and a glass sheet;

FIG. 2 is a cross-sectional view of a prior art glass laminate structure in which the polyester film is attached to installed or uninstalled glass with a pre-applied adhesive layer disposed on one side of the polyester film;

FIG. 3 is a cross-sectional view of a glass laminate structure employing the chemical composition of a preferred embodiment of the invention to enhance the adhesive bond between polyester or other plastic security film and a glass sheet as well as between multiple layers of polyester or other plastic security films;

FIG. 4 is a cross-sectional view of a glass laminate structure used in ballistic research testing and constructed with a silane-based chemical composition of a preferred embodiment of the invention applied between a glass sheet and a first plastic film layer as well as two additional plastic film layers to enhance the adhesive bonding and strength of the glass laminate structure; and

FIG. 5 is a cross-sectional view of a glass laminate structure used in hurricane impact research testing and constructed with a silane-based chemical composition of a preferred embodiment of the invention applied between a glass sheet and a first plastic film layer and with an acrylic-based chemical composition of a preferred embodiment of the invention applied between three additional plastic film layers to enhance the adhesive bonding and strength of the glass laminate structure.

### DESCRIPTION OF THE PREFERRED EMBODIMENTS OF THE INVENTION

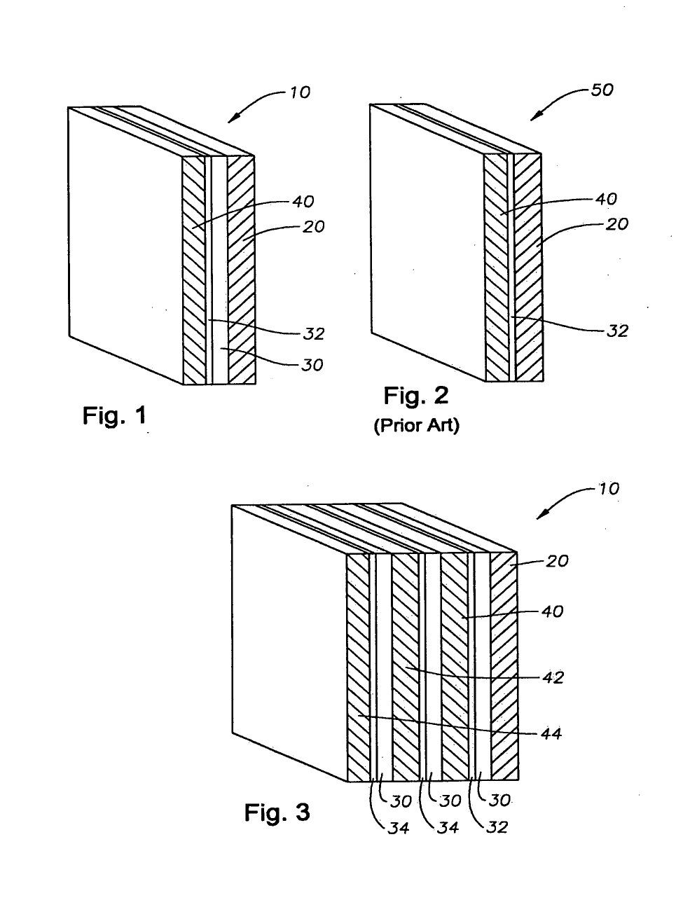

The preferred embodiment of the invention alleviates one or more of the deficiencies described in the prior art and incorporates one or more of the objects previously identified. Referring now to the drawings, FIG. 1 illustrates the cross-sectional view of a glass laminate structure 10 which has a thin layer 30 representing the chemical composition of a preferred embodiment of the invention applied between a polyester film 40 and a glass sheet 20 to enhance the adhesive bonding between the polyester film 40 and the glass sheet 20 and to enhance the strength and bullet resistant properties of the overall structure 10. Preferably, the polyester film 40 is applied to the side of the glass 20 which will not experience direct exposure to the elements that the glass laminate structure 10 is arranged and designed to resist.

The chemical composition of a preferred embodiment of the invention is intended for use in combination with commercially available glass laminate systems 50, as shown in FIG. 2, in which a polyester or other plastic security film 40 is applied and bonded to the glass 20 with an adhesive 32. Most of the commercial glass laminate systems are arranged and designed so that the polyester or other plastic security film may be applied to existing/pre-installed glass rather than to uninstalled glass. However, the chemical composition may be applied to either installed or uninstalled glass. As previously described, the polyester or other plastic security film 40 in these glass laminate systems 50 is typically manufactured with an adhesive coating 32 on one side for pressure application onto a glass sheet 20 without the need for any additional adhesives. Typically, however, a soap and water mixture (not shown) is applied to the glass surface 20 and/or film surface 40 to be bonded in order to facilitate slight adjustment and alignment of the film 40 on the glass 20 after placement but before setting of the adhesive 32.

Referring now to FIG. 1, in a preferred method of the invention, the chemical composition of a preferred embodiment is applied to the glass 20 onto which the polyester sheet 40 is to be applied as well as to the adhesive side 32 of the polyester film 40. While the chemical composition is preferably applied to both surfaces 20, 40, application to just the glass surface 20 or to the plastic film surface 40 will also provide similarly beneficial results. The chemical composition is preferably applied to the surfaces to be mated 20, 40 by spraying the surfaces 20, 40 thoroughly so that the surfaces 20, 40 are effectively saturated with the chemical composition. A simple spray bottle (not shown) filled with the liquid chemical composition is preferably used to apply and evenly distribute the chemical composition on the surfaces to be mated 20, 40; however, the liquid chemical composition may alternatively be applied to the surfaces 20, 40 in any known manner.

The chemical composition of preferred embodiment, as represented by layer 30, serves at least a dual purpose. First, as with the prior art soap and water mixtures, the chemical composition allows the polyester film 40 to be moved and properly aligned on the glass sheet 20 with greater ease after initial placement. Second, the chemical composition enhances the bonding properties of the pre-coated adhesive 32 on the polyester film 40 to enhance the overall strength and bullet resistance of the glass laminate structure 10.

In a preferred embodiment of the invention, the chemical composition is an acrylic-based mixture preferably containing additional components to enhance the strength properties of the structure as well as facilitate the application of the polyester film onto the glass sheet. The acrylic used as a base compound in the mixture is preferably a liquid acrylic adhesive, such as N-580 and N-1031 manufactured by Rohm & Haas. The liquid acrylic serves as an adhesive which is similar to and complements the adhesive that is pre-applied on polyester and other plastic security films currently used to strengthen glass by bonding the plastic film to glass. Of all the liquid acrylics commercially available, N-580 and N-1031 manufactured by Rohm & Hass are preferred, because they resist yellowing over time. Yellowing of the acrylic between the polyester film and the glass sheet increases the opacity of the glass laminate structure, thereby reducing optical transparency. While conventional liquid acrylics tend to turn yellow with repeated and extensive exposure to ultraviolet light, the N-580 and N-1031 liquid acrylics have been shown to mitigate such yellowing. Table 1 gives the relative amounts of liquid acrylic adhesive as compared to other components that are preferably used to generate the chemical composition.

Acrylic chemistry is well known by those skilled in the art and will only be briefly discussed herein. Acrylic adhesives and materials are composed of polymeric compounds, specifically polyacrylates polymerized from acrylate monomers. Polyacrylates are long linear polymer chains with molecular weights as high as 80,000 and are created when polymerization occurs with acrylate monomers or with other vinyl-containing monomers. The acrylate monomers are derived from alkyl esters of acrylic acid and/or methacrylic acid. Acrylate polymers are well known by those skilled in the art for their adhesive bonding characteristics and include, but are not limited to, such compounds as methyl acrylate, methyl methacrylate, butyl methacrylate, and butyl acrylate. Additional compounds, such as fillers, solvents, thixotropic agents, catalysts and plasticizers are typically added during the polymerization of polyacrylates to achieve the desired properties of the acrylic adhesives and other materials. For example, if a less viscous acrylic adhesive is desired, a greater percentage of a solvent, such as toluene or xylene, may be added to the acrylic resin.

In a preferred embodiment, the acrylic-based chemical composition also contains an alcohol, such as methyl alcohol, isopropyl alcohol, or ethyl alcohol, which serves as a carrier agent or solvent for composition components in addition to any carrier agent or solvent that may already be a part of the liquid acrylic adhesive. Methyl alcohol is preferred over other alcohols, because methyl alcohol binds more effectively with the liquid acrylic as well as with the components in the pressure sensitive adhesive disposed on the polyester film. Other alcohols, such as isopropyl alcohol and ethyl alcohol, also perform well but not as well as methyl alcohol in promoting the adhesive bond between polyester and glass. Low molecular weight alcohols are well known to those skilled in the art as effectively carrier agents, because they evaporate readily after surface application thereby leaving only the desired chemical composition. The evaporation of the carrier agent and/or solvents also permits and facilitates a faster curing of the acrylic resin adhesive. Table 1 gives the amount of alcohol as a range that is preferably added to the acrylic-based chemical composition. As previously indicated, methyl alcohol, such as the 99% methyl alcohol manufactured by Chevron, is preferred. The strength of the alcohol used in the acrylic-based chemical composition is of minimal importance, because the chemical composition is ultimately diluted with de-ionized water.

In a preferred embodiment, the acrylic-based chemical composition also contains a glycol, preferably polyethylene glycol (PEG) 8000 manufactured by Fisher Scientific, which reacts with the acrylic and other components to enhance the strength properties of the glass laminate bond. The PEG may also react with the adhesive, often an acrylic adhesive, which comes pre-applied on one side of commercially-available polyester or other plastic security films. PEG is also used in the acrylic-based chemical composition as a wetting and slip agent. PEG is well known by those skilled in the art as a flexible, water-soluble polymer with many applications in the medical and personal care industries. For example, PEG has thickening and foam stabilizing properties and is often combined with glycerin in the production of skin creams and lubricants. Here, too, glycerin is also preferably added to the acrylic-based chemical composition. In the acrylic-based chemical composition, glycerin serves as a slip agent or lubricant to reduce the friction between the polyester film and the glass sheet, thereby permitting easier movement and alignment of the polyester film after placement onto the glass sheet. While glycerin, such as the glycerin manufactured by the Ferro Corporation, is preferred, a synthetic slip agent or lubricant, such as Dow Corning® 30 (propylene carbonate at 40-70%), may be alternatively used in place of the glycerin.

In addition to the PEG and glycerin (or a synthetic substitute), a fluorosurfactant, such as Dupont Zonyl® FSH or FSJ, is also preferably added to the acrylic-based chemical composition to ensure that the entire glass and/or polyester surfaces are properly wetted by the chemical composition. Fluorosurfactants are super wetting compounds that, in addition to wetting, provide leveling and increased penetration into the substrate to achieve a deeper and stronger adhesion. While fluorosurfactants, such as Dupont Zonyl®FSH or FSJ are the preferred wetting agents, Dow Corning® 193 (dimethyl, methyl(polyethylene oxide)silocane @ 60%, polyethylene oxide monoallyl ether @ 10-30%, and polyethylene glycol @ 7-13%) provides a suitable alternative. However, Dow Corning® 193 is specially designed to work with silane-based and silicone-based products in conjunction with glass laminates.

Table 1 gives the relative amounts of PEG, glycerin, and fluorosurfactant as compared to other components that are preferably used to generate the desired acrylic-based chemical composition of a preferred embodiment. The acrylic-based chemical composition, containing liquid acrylic adhesive, methyl alcohol, PEG, glycerin, and fluorosurfactant, is sufficiently diluted with de-ionized water. While water other than de-ionized water is adequate to dilute the mixture, de-ionized water, such as the de-ionized water manufactured by CHEMCENTRAL, is preferred. As shown in Table 1, the acrylic-based chemical composition is preferably diluted to one gallon (3,785 milliliters) using de-ionized water as the diluent. Other suitable diluents are well known to those skilled in the art and may be used in place of the preferred de-ionized water diluent.

The individual components used in creating the acrylic-based chemical composition of a preferred embodiment of the invention are preferably combined and mixed together in a particular order. First, the PEG is added to the methyl alcohol in the relative amounts as listed in Table 1. The PEG and methyl alcohol are then diluted to one gallon using de-ionized water. Glycerin (or a synthetic substitute) and the fluorosurfactant are next added to the diluted mixture. The mixture is then allowed to set for a sufficient time, preferably twenty-four hours. Finally, the liquid acrylic adhesive is added to complete the chemical composition. While a particular order for preparing the acrylic-based chemical composition is preferred, a different procedure for preparing the chemical composition may also provide a similarly useful, if not identical, chemical composition.

In an alternative preferred embodiment of the invention, the chemical composition is an silane-based mixture preferably containing additional components to enhance the strength properties of the structure as well as facilitate the application of the polyester film onto the glass sheet. The silane used as a base compound in the mixture is preferably a liquid silane, such as Dow Corning® Z-6020 (aminoethylaminopropyltrimethoxysilane @60%, methoxysilane @ none, methyl alcohol @<1.0%, and ethylenediamine @<1.0%) and Dow Corning® Z-6040 (glycidoxypropyl trimethoxysilane @ 100%). The liquid silane serves as an adhesion promoter and binder which is similar to and complements the acrylic adhesive that is typically pre-applied on polyester and other plastic security films currently used to strengthen glass by bonding the plastic film to glass. An added benefit of using liquid silane is that, unlike conventional acrylics, silane-based compounds are resistant to yellowing when repeatedly and extensively exposed to ultraviolet light. The silane-based adhesion promoters are also much smaller molecules than their acrylic-based counterparts, therefore the nano-sized silane compounds are able to penetrate deeper into the natural pores of the glass and polyester film, thereby producing greater glass laminate adhesion. Table 2 gives the relative amounts of liquid silane as compared to other components that are preferably used to generate the desired silane-based chemical composition.

Silane chemistry is well known by those skilled in the art and will only be briefly discussed herein. Silane, otherwise known as silicane, is the silicon analogue of methane having four hydrogen atoms attached to the silicon atom. Like polymeric carbon compounds, silanes may also form saturated and unsaturated polymeric chains consisting of silicon and hydrogen atoms. Silanes may be gaseous or liquid compounds depending on the size and/or length of the polymer chain. Organofunctional silanes, or silanes with organic groups substituted in place of hydrogen groups, are particularly useful for their ability to bond organic polymer systems to inorganic substrates.

In a preferred embodiment, the silane-based chemical composition also contains an alcohol, such as methyl alcohol, isopropyl alcohol, or ethyl alcohol, which serves as a carrier agent or solvent for composition components in addition to any carrier agent or solvent that may already be a part of the liquid silane. Methyl alcohol is preferred over other alcohols, because methyl alcohol binds more effectively with the liquid silane as well as with the components in the pressure sensitive adhesive disposed on the polyester film. Other alcohols, such as isopropyl alcohol and ethyl alcohol, also perform well but not as well as methyl alcohol in promoting the adhesive bond between polyester and glass. Low molecular weight alcohols are well known to those skilled in the art as effectively carrier agents, because they evaporate readily after surface application thereby leaving only the desired chemical composition. The evaporation of the carrier agent and/or solvents also permits and facilitates a faster curing of the adhesives and/or adhesion promoters. Table 2 gives the amount of alcohol as a range that is preferably added to the silane-based chemical composition. As previously indicated, methyl alcohol, such as the 99% methyl alcohol manufactured by Chevron, is preferred. The strength of the alcohol used in the silane-based chemical composition is of minimal importance, because the chemical composition is ultimately diluted with de-ionized water.

In a preferred embodiment, the silane-based chemical composition also contains a glycol, preferably a silicone glycol copolymer such as Dow Corning® 193, which reacts with the silane and other components to enhance the strength properties of the glass laminate bond. The silicone glycol copolymer may also react with the adhesive, often an acrylic adhesive, which comes pre-applied on one side of commercially-available polyester or other plastic security films. Silicone glycol copolymer is also used in the silane-based chemical composition as a super wetting compound. In addition to wetting, the silicone glycol copolymer also provides leveling and facilitates increased penetration of the liquid silane into the substrate pores to achieve a deeper and stronger adhesion. An added benefit of the Dow Corning® 193 silicone glycol copolymer is that it is specially designed to work with silane-based (and silicon-based products) in conjunction with glass laminates. Because the silicone glycol copolymer acts as a super wetting compound, an additional fluorosurfactant wetting agent, such as Dupont Zonyl® FSH or FSJ, is not added to the silane-based chemical composition. However, a slip agent or lubricant, such as Dow Corning@ 30, is preferably added to the silane-based chemical composition. The slip agent or lubricant is used to reduce the friction between the polyester film and the glass sheet, thereby permitting easier movement and alignment of the polyester film after placement onto the glass sheet. While Dow Corning 30 is the preferred slip agent for the chemical composition, glycerin may alternatively be used.

Table 2 gives the relative amounts of the glycol and slip agent as compared to other components that are preferably used to generate the desired silane-based chemical composition of a preferred embodiment. The silane-based chemical composition, containing liquid silane, methyl alcohol, glycol, and a slip agent, is sufficiently diluted with de-ionized water. While water other than de-ionized water is adequate to dilute the mixture, de-ionized water, such as the de-ionized water manufactured by CHEMCENTRAL, is preferred. As shown in Table 2, the silane-based chemical composition is preferably diluted to one gallon (3,785 milliliters) using de-ionized water as the diluent. Other suitable diluents are well known to those skilled in the art and may be used in place of the preferred de-ionized water diluent.

The individual components used in creating the silane-based chemical composition of a preferred embodiment of the invention are preferably combined and mixed together in a particular order. First, the liquid silane is added to the de-ionized water in the relative amount as listed in Table 2. The mixture is then allowed to set for a sufficient time, preferably at least thirty minutes, in order to hydrolyze the liquid silane. Next, the alcohol, and then the slip and wetting agents are added to the hydrolyzed liquid silane mixture in the relative amounts listed in Table 2. While a particular order for preparing the silane-based chemical composition is preferred, a different procedure for preparing the chemical composition may also provide a similarly useful, if not identical, chemical composition.

The prepared acrylic-based or silane-based chemical composition has a very low viscosity which is similar to the viscosity of water and lends itself to easy application in any known manner for water-based solutions. As previously described, a simple spray bottle is preferably filled with the chemical composition for subsequent application to polyester and glass surfaces. Referring now to FIG. 1, in a preferred method of the invention, the glass 20 onto which the polyester film 40 is to be placed is first cleaned using any known glass cleaning method. A commercially available glass cleaner is preferably used along with a clean towel to remove any foreign debris or grease from the glass surface 20. After the glass surface 20 is cleaned and then dried, either the acrylic-based or silane-based chemical composition is applied to the glass surface 20 using a spraying technique which will evenly distribute the chemical composition on the glass surface 20. Application continues until the glass surface 20 is fully saturated with the prepared chemical composition.

Next, the polyester or other plastic film 40 to be placed on the glass surface 20 is prepared. If a commercially available polyester or other plastic security film 40 with a pre-applied adhesive layer 32 on one side is to be used, the protective layer (not shown) covering the pre-applied adhesive 32 is removed. The chemical composition is then applied to the adhesive surface 32 of the polyester or other plastic security film 40 using a spraying technique which will evenly distribute the chemical composition on the adhesive surface 32. Application continues until the polyester surface 40 is fully saturated with the chemical composition.

After the two surfaces to be mated 20, 40 are saturated with the prepared chemical composition, the polyester or other plastic security film 40, with its adhesive side 32 toward the glass 20, is aligned and placed onto the glass 20. Before the adhesives set, the polyester or other plastic security film 40 may be moved and adjusted by sliding the film 40 over and along the glass surface 20. Once the security film 40 is properly positioned and aligned, an additional amount of the chemical composition is preferably sprayed onto the outer surface of the polyester or other plastic security film 40. A simple squeegee (not shown) is then used to remove any air bubbles trapped between the film 40 and the glass surfaces 20, to remove any excess chemical composition from between the surfaces 20, 40, and to ensure that a good contact between the film 40 and the glass 20 is made before the adhesives set. The chemical composition applied to the outer surface of the security film 40 provides needed lubrication for moving the squeegee (not shown) along the outer surface of the security film 40 without unintentionally displacing the security film 40 from the glass 20.

The preferred embodiments of the chemical composition are arranged and designed to facilitate a short curing time and to create a secure bond between the plastic security film 40 and the glass sheet 20. When using a preferred embodiment of the chemical composition, the bond between the plastic film 40 and the glass 20 normally sets within fifteen minutes of placement; however the bond is not fully cured until seventy-two hours after application. Once the bond is fully cured, removing the film 40 from the glass 20 is more difficult than if the chemical composition is not used in the application.

As shown in FIG. 3, the strong bond created by using a preferred embodiment of the chemical composition allows several layers of plastic security film 40, 42, 44 to be applied, for example, one 42, 44 on top of another 40, 42 for additional strength without compromising the integrity or clarity of the glass 20. Thus, the chemical composition performs equally well when enhancing the adhesive bonding between several layers of polyester or other plastic security films 40, 42, 44. Either the acrylic-based or silane-based chemical composition of a preferred embodiment of the invention may be used between the glass sheet 20 and the plastic security film 40 as well as between any additional layers of plastic security film 40, 42, 44. Alternatively, the acrylic-based chemical composition may be used between the glass sheet 20 and the plastic security film 40 while the silane-based chemical composition is used between the plastic security films 40, 42, 44. Conversely, the silane-based chemical composition may be used between the glass sheet 20 and the plastic security film 40 while the acrylic-based composition is used between the plastic security films 40, 42, 44.

Several research tests, including ballistic and hurricane impact tests, have been conducted which confirm the enhanced glass laminate strength and bullet resistant properties imparted by the preferred embodiments of the chemical composition and method of applying same. The ballistic research tests were conducted at the Montgomery County, Texas, Emergency Services Training Facility under Range Command by Commissioned Range Instructors. The controlled ballistic testing procedures used were in accordance to the National Institute of Justice Ballistic Testing guidelines in terms of projectiles, velocities, and distance. The hurricane impact tests were also conducted at the Montgomery County, Texas, Emergency Services Training Facility and were performed according to Miami Dade Building Codes for glass laminates by Construction Consulting Laboratories of Dallas, Tex. The glass laminate structures tested were actually subjected to more severe testing conditions than those required by the Miami Dade Building Codes.

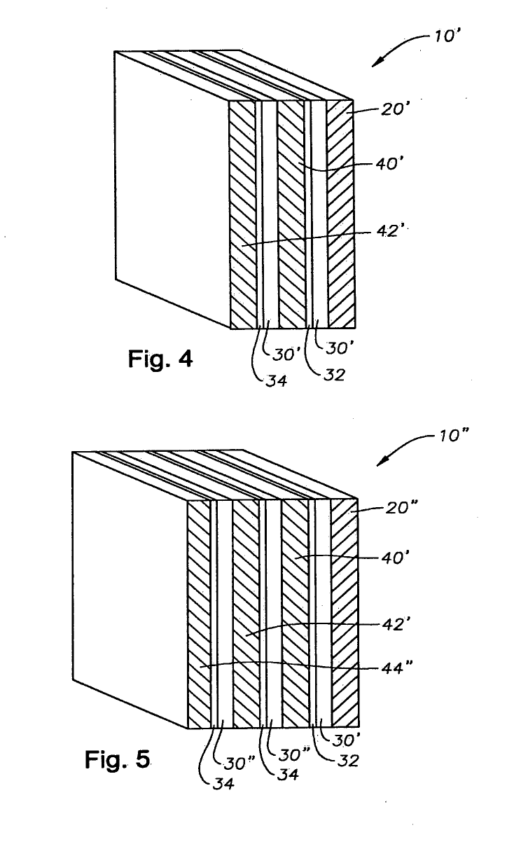

For the ballistic research tests, a silane-based composition prepared using the most preferable composition given in Table 2 was applied according to the preferred method of the invention between a glass sheet and a first Mylar® plastic film layer as well as the multiple Mylar® plastic film layers. In a first ballistic test, a glass laminate 10′ (FIG. 4) comprising a ¼ inch annealed glass sheet 20′ and two layers of 11 mil Mylar plastic security film 40′, 42′ was constructed using the aforementioned silane-based chemical composition 30′. This glass laminate structure 10′, as shown in FIG. 4, consistently stopped multiple .22 caliber projectiles, with some projectiles not even breaking the glass 20′. All of the .22 caliber projectiles were stopped with no penetration or spalling and no delamination. A control glass laminate (not shown) constructed and treated with only a prior art soap and water composition failed to stop the .22 caliber projectiles with penetration and spalling occurring as well as delamination of the laminate and structural failure. In a second ballistic test, a glass laminate (not shown) comprising a ⅜ inch annealed glass sheet and four layers of 11 mil Mylar® plastic security film was constructed using the aforementioned silane-based chemical composition. This glass laminate structure (not shown) consistently stopped multiple .38 caliber projectiles, with some projectiles not even breaking the glass. All of the .38 caliber projectiles were stopped with no penetration or spalling and no delamination. A control glass laminate constructed and treated with only a prior art soap and water composition failed to stop the .38 caliber projectiles with penetration and spalling occurring as well as delamination of the laminate and structural failure.

For the hurricane impact research tests, as shown in FIG. 5, a silane-based composition 30′ prepared using the most preferable composition given in Table 1 was applied according to the preferred method of the invention between a glass sheet 20″ and a first Mylar® plastic film layer 40′. An acrylic-based composition 30″ prepared using the most preferable composition given in Table 2 was then applied according to the preferred method of the invention between the multiple Mylar® plastic film layers 40′, 42′, 44″. In the hurricane impact test, a glass laminate 10″ comprising a 33 inch by 66 inch, 3/16 inch thick insulated tempered glass sheet 20″ and three layers of 11 mil Mylar plastic security film 40′, 42′, 44″ was constructed. This glass laminate structure 10″, treated with the respective chemical compositions 30′, 30″, was struck six times by the large missile projectile used in the test. The pressure of the large missile for each shot was steadily increased from the minimum 9 psig pressure that is required by the Code to the maximum tested pressure of 35 psig. The treated glass laminate structure 10″ repeatedly repelled the large missile projectile with no penetration and no delamination while maintaining structural integrity. A control glass laminate (not shown) constructed and treated with only a prior art soap and water composition failed to stop the large missile projectile with penetration and spalling occurring as well as delamination of the laminate and structural failure.

The Abstract of the disclosure is written solely for providing the United States Patent and Trademark Office and the public at large with a means by which to determine quickly from a cursory inspection the nature and gist of the technical disclosure, and it represents solely a preferred embodiment and is not indicative of the nature of the invention as a whole.

While some embodiments of the invention have been illustrated in detail, the invention is not limited to the embodiments shown; modifications and adaptations of the above embodiment may occur to those skilled in the art. Such modifications and adaptations are in the spirit and scope of the invention as set forth herein:

What is claimed is:

1. An adhesion promoter composition for strengthening the adhesive bonding between glass and polyester film in a glass laminate structure, said adhesion promoter composition comprising,
between 5 and 180 milliliters of a liquid acrylic per 3,785 milliliters of said composition;
between 10 and 180 milliliters of a glycol per 3,785 milliliters of composition;
between 10 and 360 milliliters of an alcohol per 3,785 milliliters of said composition;
between 0.25 and 20 milliliters of a slip agent per 3,785 milliliters of said composition; and
water as a diluent for said composition.

2. The composition of claim 1 further comprising,
between 0.10 and 10 milliliters of a fluorosurfactant per 3,785 milliliters of said composition.

3. The composition of claim 1 wherein,
said liquid acrylic is an acrylate polymer selected from the group consisting of methyl acrylate, methyl methacrylate, butyl methacrylate, and butyl acrylate.

4. The composition of claim 1 wherein,
said glycol comprises a polyethylene glycol.

5. The composition of claim 1 wherein,
said alcohol comprises methyl alcohol.

6. The composition of claim 1 wherein,
said slip agent comprises glycerin.

7. The composition of claim 1 wherein,
the concentration of said liquid acrylic is between 15 and 90 milliliters per 3,785 milliliters of said composition; and
the concentration of said glycol is between 15 and 90 milliliters per 3,785 milliliters of said composition.

8. An adhesion promoter composition for strengthening the adhesive bonding between glass and polyester film in a glass laminate structure, said adhesion promoter composition comprising,
between 1 and 40 milliliters of a silane per 3,785 milliliters of said composition;
between 0.5 and 10 milliliters of a glycol per 3,785 milliliters of said composition;
between 100 and 1,500 milliliters of an alcohol per 3,785 milliliters of said composition,
between 0.5 and 10 milliliters of a slip agent per 3,785 milliliters of said composition; and
water as a diluent for said composition.

9. The composition of claim 8 wherein,
said silane comprises a trimethoxysilane.

10. The composition of claim 8 wherein,
said glycol comprises a silicone glycol copolymer.

11. The composition of claim 8 wherein,
said alcohol comprises methyl alcohol.

12. The composition of claim 8 wherein,
said slip agent comprises propylene carbonate.

13. The composition of claim 8 wherein,
said slip agent comprises glycerin.

14. The composition of claim 8 wherein,
the concentration of said silane is between 10 and 20 milliliters per 3,785 milliliters of said composition; and
the concentration of said glycol is between 1 and 5 milliliters per 3,785 milliliters of said composition.

15. A method for strengthening the adhesive bonding between glass (20) and plastic (40) layers in a glass laminate structure (10), said method comprising the steps of:
obtaining an adhesion promoter composition for strengthening the adhesive bonding between glass (20) and plastic (40) in a glass laminate structure (10); said adhesion promoter composition comprising between 1 and 40 milliliters of a silane per 3,785 milliliters of said composition, between 0.5 and 10 milliliters of a glycol per 3,785 milliliters of said composition, between 100 and 1,500 milliliters of an alcohol per 3,785 milliliters of said composition, between 0.5 and 10 milliliters of a slip agent per 3,785 milliliters of said composition, and water as a diluent for said composition;
applying said adhesion promoter composition to a glass surface (20);
placing a plastic film (20) having an adhesive layer (32) onto said glass surface (20) such that said adhesion promoter composition forms a thin layer (30) between said glass surface (20) and said adhesive layer (32) of said film (40); and
removing air bubbles trapped between said glass surface (20) and said film (40).

16. The method of claim 15 wherein,
said silane comprises a trimethoxysilane.

17. The method of claim 15 wherein,
said glycol comprises a silicone glycol copolymer.

18. The method of claim 15 further comprising the step of:
applying said adhesion promoter composition to said adhesive layer of said film.

19. The method of claim 15 wherein,
said plastic film is a polyester film.

20. The method of claim 15 wherein,
said step of removing air bubbles trapped between said glass surface (20) and said film (40) is accomplished using a squeegee.

21. The method of claim 15 further comprising the steps of:
applying said adhesion promoter composition onto a side of said film (40) opposite from said adhesive layer (32);
placing an additional plastic film (42) having an adhesive layer (34) onto said film (40) such that said adhesion promoter composition forms a thin layer (30) between said film (40) and said adhesive layer (34) of said additional film (42); and
removing air bubbles trapped between said film (40) and said additional film (42).

22. The method of claim 15 further comprising the steps of:
obtaining a second adhesion promoter composition for strengthening the adhesive bonding between plastic film layers (40, 42) in a glass laminate structure (10); said second adhesion promoter composition comprising between 5 and 180 milliliters of a liquid acrylic per 3,785 milliliters of said composition, between 10 and 180 milliliters of a glycol per 3,785 milliliters of composition, between 10 and 360 milliliters of an alcohol per 3,785 milliliters of said composition, between 0.25 and 20 milliliters of a slip agent per 3,785 milliliters of said composition, and water as a diluent for said second composition;
applying said second adhesion promoter composition onto a side of said film (40) opposite from said adhesive layer (32);
placing an additional plastic film (42) having an adhesive layer (34) onto said film (40) such that said second adhesion promoter composition forms a thin layer (30) between said film (40) and said adhesive layer (34) of said additional film (42); and
removing air bubbles trapped between said film (40) and said additional film (42).

23. A method for strengthening the adhesive bonding between glass (20) and plastic (40) layers in a glass laminate structure (10), said method comprising the steps of:
obtaining an adhesion promoter composition for strengthening the adhesive bonding between glass (20) and plastic (40) in a glass laminate structure (10); said adhesion promoter composition comprising between 5 and 180 milliliters of a liquid acrylic per 3,785 milliliters of said composition, between 10 and 180 milliliters of a glycol per 3,785 milliliters of composition, between 10 and 360 milliliters of an alcohol per 3,785 milliliters of said composition, between 0.25 and 20 milliliters of a slip agent per 3,785 milliliters of said composition, and water as a diluent for said composition;
applying said adhesion promoter composition to a glass surface (20);
placing a plastic film (20) having an adhesive layer (32) onto said glass surface (20) such that said adhesion promoter composition forms a thin layer (30) between said glass surface (20) and said adhesive layer (32) of said film (40); and
removing air bubbles trapped between said glass surface (20) and said film (40).

24. The method of claim 23 wherein,
said liquid acrylic is an acrylate polymer selected from the group consisting of methyl acrylate, methyl methacrylate, butyl methacrylate, and butyl acrylate.

25. The method of claim 23 wherein,
said glycol comprises a polyethylene glycol.

26. The method of claim 23 further comprising the step of:
applying said adhesion promoter composition to said adhesive layer of said film.

27. The method of claim 23 wherein,
said plastic film is a polyester film.

28. The method of claim 23 wherein,
said step of removing air bubbles trapped between said glass surface (20) and said film (40) is accomplished using a squeegee.

29. The method of claim 23 further comprising the steps of:
applying said adhesion promoter composition onto a side of said film (40) opposite from said adhesive layer (32);
placing an additional plastic film (42) having an adhesive layer (34) onto said film (40) such that said adhesion promoter composition forms a thin layer (30) between said film (40) and said adhesive layer (34) of said additional film (42); and
removing air bubbles trapped between said film (40) and said additional film (42).

30. The method of claim 23 further comprising the steps of:
obtaining a second adhesion promoter composition for strengthening the adhesive bonding between plastic film layers (40, 42) in a glass laminate structure (10); said second adhesion promoter composition comprising between 1 and 40 milliliters of a silane per 3,785 milliliters of said composition, between 0.5 and 10 milliliters of a glycol per 3,785 milliliters of said composition, between 100 and 1,500 milliliters of an alcohol per 3,785 milliliters of said composition, between 0.5 and 10 milliliters of a slip agent per 3,785 milliliters of said composition, and water as a diluent for said second composition;
applying said second adhesion promoter composition onto a side of said film (40) opposite from said adhesive layer (32);
placing an additional plastic film (42) having an adhesive layer (34) onto said film (40) such that said second adhesion promoter composition forms a thin layer (30) between said film (40) and said adhesive layer (34) of said additional film (42); and
removing air bubbles trapped between said film (40) and said additional film (42).

31. A bullet-resistant glass laminate (10) comprising,
a glass sheet (20);
a polyester film (40) having an adhesive (32) applied on at least one side thereof for bonding said polyester film (40) to said glass sheet (20); and
an adhesion promoter composition (30) disposed between said glass sheet (20) and said polyester film (40), said adhesion promoter composition (30) comprising between 1 and 40 milliliters of a silane per 3,785 milliliters of said composition, between 0.5 and 10 milliliters of a glycol per 3,785 milliliters of said composition, between 100 and 1,500 milliliters of an alcohol per 3,785 milliliters of said composition, between 0.5 and 10 milliliters of a slip agent per 3,785 milliliters of said composition, and water as a diluent for said composition.

32. A bullet-resistant glass laminate (10) comprising,
a glass sheet (20);
a polyester film (40) having an adhesive (32) applied on at least one side thereof for bonding said polyester film (40) to said glass sheet (20); and
an adhesion promoter composition (30) disposed between said glass sheet (20) and said polyester film (40), said adhesion promoter composition (30) comprising between 5 and 180 milliliters of a liquid acrylic per 3,785 milliliters of said composition, between 10 and 180 milliliters of a glycol per 3,785 milliliters of composition, between 10 and 360 milliliters of an alcohol per 3,785 milliliters of said composition, between 0.25 and 20 milliliters of a slip agent per 3,785 milliliters of said composition, and water as a diluent for said composition.
